(19) United States
(12) Patent Application Publication
(10) Pub. No.: US 2006/0238773 A1
(43) Pub. Date: Oct. 26, 2006

(54) Interferometer optical element alignment

(75) Inventors: Peter Eric Wellstead, Stockport (GB); John Meirion, High Peak (GB)

Correspondence Address: PILLSBURY WINTHROP SHAW PITTMAN LLP, P.O BOX 10500, McLean, VA, 22102, US

(73) Assignee: ACIMETRICS LIMITED, MANCHESTER, M13 9XX (GB)

(21) Appl. No.: 10/525,267

(22) PCT Filed: Aug. 21, 2003
(86) PCT No.: PCT/GB03/03664

§ 371 Date: Jun. 2, 2006

(30) Foreign Application Priority Data
Aug. 23, 2002 (GB) 0219808.3

(51) Int. Cl. G01B 11/02

(52) U.S. Cl. 356/510

(57) ABSTRACT

A method for aligning an optical element of an optical interferometer in which a beam of light interacts with the optical element and the optical element is tilted about first and second axes to adjust the relative phase of components of the beam. At least three parallel alignment beams of monochromatic light are directed through the interferometer towards respective detectors. The detectors are arranged in pairs such that tilting the optical element about the first axis does not affect the relative phase of components of each of the beams directed towards a first pair of detectors and tilting the optical element about the second axis does not affect the relative phase of components of each of the beams directed towards the second pair of detectors. One detector may form part of each of the first and second pairs of detectors. A first estimate of an aligned optical element position is derived by determining from an output of at least one detector a first element position at which the magnitude of the beam incident on that detector is a maximum. Second estimates of aligned element positions are also derived by determining second element positions at which the phase differences between beams incident on each of the pairs of detectors are a minimum. The element is aligned by moving it to a final position which is one of the second positions which is at or adjacent the first position. A set of second element positions may be determined, the element being moved to each of the set of second element positions in turn. The magnitude of outputs of at least one of the detectors may then be monitored at each of the second element positions to which the element is moved, and the element may be moved to the final position which corresponds to the position at which the monitored magnitude is a maximum.

The present invention relates to a method and apparatus for aligning an optical element such as a mirror, for example a mirror of an optical interferometer.

Two-beam optical interferometers are widely used in optical measurement apparatus. Applications of such interferometers include the alignment and testing of optical systems and elements, such as compound lenses and communication systems using optical fibres. Interferometers make it possible to measure small differences in optical phase between an ideal beam (generally referred to as the reference beam) and a further beam which has been transmitted through or reflected by a lens, mirror or other optical component which is under test. The Twyman-Green interferometer is one example of this type of instrument although there are many others.

Two-beam interferometers are known in which an optical path difference is deliberately generated and varied in a controlled manner. Such interferometers, of which the Michelson interferometer is one example, are widely used for spectral analysis, particularly for the visible or near infrared regions of the electromagnetic spectrum. Michelson interferometers have many industrial applications, particularly in the chemical and pharmaceutical industries, and are used for process control and quality monitoring in a very wide range of industrial applications.

Optical testing and spectral analysis instruments call for high precision so as to maintain precisely known optical path differences between optical beams of the instrument. Alignment of optical components must be achieved before the interferometer is used, and maintained during use. This calls for a high degree of stability and precision with regard to both optical and mechanical characteristics.

In a typical Michelson interferometer, a broadband source provides a beam which is directed towards a beam splitter which splits the beam into two components. One component is reflected by the beam splitter towards a mirror which reflects it back through the beam splitter to the analytical detector, and the other component is transmitted by the beam splitter and reflected back by a second mirror, and then reflected by the beam splitter towards the analytical detector. The mirrors and beam splitter are arranged so that the two components incident on the analytical detector are co-linear. One of the mirrors is movable, so that the optical path length travelled by one component between the source and analytical detector can be varied. One mirror is provided with means for adjusting and maintaining its alignment. The magnitude of the intensity of the beam sensed by the analytical detector depends upon the optical path difference between the two component beams. By varying the position of the movable mirror the optical path difference between the two beam paths can be varied. This in turn varies the magnitude of the detected beam. A plot of variations in magnitude as a function of the optical path difference is known as an interferogram, and the spectral structure of the light detected by the instrument is normally derived by frequency analysis (usually Fourier Transformation) of the interferogram. The spectral structure can in turn be used to determine characteristics of the beam source and material that the beam has either passed through or been reflected from in the instrument. In addition, generally at least one monochromatic light source is arranged adjacent the main beam but separate from it. The monochromatic source is used to determine the relative retardation of the mirrors and to assist in stabilising the mirrors during retardation.

Clearly the precise positioning of the mirrors relative to each other and the precise movement of the moveable mirror are fundamental to the accuracy of the instrument. Thus the mirrors must be initially aligned in a correct manner and their alignment must be maintained during use, and in particular during movement of the moveable mirror as the instrument is used. Generally initial alignment is achieved by a skilled technician visually inspecting an interference pattern incident upon the detector and making adjustments to the mirror angles accordingly. This alignment process must be repeated each time that the instrument is switched on and should be repeated at regular intervals to ensure that the instrument has not become misaligned for example as a result of exposure to a mechanical shock or vibration. Once initial alignment has been achieved, a dynamic control system is required to maintain the mirrors in alignment during mirror movement. Various proposals have been made for achieving the necessary dynamic alignment, for example that described in U.S. Pat. No. 5,657,122. That document describes a Michelson interferometer in which, in addition to the beam used for measurement purposes, three parallel monochromatic beams are directed through the instrument towards respective ones of a triangular array of detectors provided for alignment purposes. The alignment detectors provide respective output signals which control three actuators arranged in a corresponding triangular array. The outputs of the three detectors drive the actuators to cause minute adjustment to the angular orientation of the nominally fixed mirror thereby to compensate for wobble or systematic tilt of the nominally moveable mirror. This system does seek to maintain alignment during instrument use but does not provide initial alignment which still requires the intervention of a skilled technician.

It is an object of the present invention to provide a method and apparatus for aligning an optical element such as a mirror of an optical interferometer.

According to the present invention, there is provided a method for aligning an optical element of an optical interferometer in which a beam of light interacts with the optical element and the optical element is tilted about first and second axes to adjust the relative phase of components of the beam, wherein at least three alignment beams of monochromatic light are directed through the interferometer towards respective detectors, the detectors being arranged in pairs such that tilting the optical element about the first axis affects the relative phase of components of each of the beams directed towards a first pair of detectors in a predetermined manner and tilting the optical element about the second axis affects the relative phase of components of each of the beams directed towards the second pair of detectors in a predetermined manner, a first estimate of an aligned optical element position is derived by determining from an output of at least one detector a first element position at which the magnitude of the beam incident on that detector is a maximum, second estimates of aligned element positions are derived by determining second element positions at which predetermined phase differences between beams incident on each of the pairs of detectors are established, and the element is aligned by moving it to a final position which is one of the second positions which is at or adjacent the first position.

The present invention also provides an apparatus for aligning an optical element of an optical interferometer in which a beam of light interacts with the optical element and the optical element is tilted about first and second axes to adjust the relative phases of components of the beam, comprising means for directing at least three alignment beams of monochromatic light through the interferometer towards respective detectors, the detectors being arranged in pairs such that tilting the optical element about the first axis affects the relative phase of components of each of the beams directed towards a first pair of detectors in a predetermined manner and tilting the optical element about the second axis affects the relative phase of components of each of the beams directed towards a second pair of detectors in a predetermined manner, means for deriving a first estimate of an aligned optical element position by determining from an output of at least one detector a first element position at which the magnitude of the beam incident on that detector is a maximum, means for deriving second estimates of aligned element positions by determining second element positions at which predetermined phase differences between beams incident on each of the pairs of detectors are established, and means for aligning the element by moving it to a final position which is one of the second positions which is at or adjacent the first position.

The axes may be orthogonal to simplify the geometrical arrangement, although other configurations are possible. The beams may be parallel, as this also results in relatively simple geometry, although again other configurations are possible. Preferably, the detectors are arranged such that tilting the optical element about the first axis does not affect the relative phase of components of each of the beams directed towards a first pair of the detectors and tilting the optical element about the second axis does not affect the relative phase of components of each of the beams directed towards the second pair of detectors, the second estimates of aligned element positions being derived by determining second element positions at which the phase differences between beams instant on each of the pairs of detectors are a minimum.

The first element position may be derived by calculating element positions from the outputs of each of the detectors such that each calculated element position corresponds to a position at which the magnitude of the beam incident on the respective detector is a maximum, the first element position being determined by combining the calculated element positions. Each of the first and second pairs of detectors may include a common detector, three of the detectors being arranged in a triangular pattern. Further detectors may also be provided to generate additional magnitude signals, these signals being used to improve overall system performance and to check for errors.

A set of second element positions may be determined. The element may simply be aligned by moving it to the second position which is closest to the first element position. Alternatively or in addition the element may be moved to each of the set of second element positions in turn, the magnitude of outputs of at least one of the detectors may be monitored at each position, and the element may be moved to a final position corresponding to the second element position at which the monitored magnitude is a maximum.

The optical element which is movable may be a movable mirror in for example a Michelson interferometer, and the movable optical element may be tilted by a plurality of actuators each of which is aligned with the respective detector on the beam path extending to that detector.

An embodiment of the present invention will now be described, by way of example, with reference to the accompanying drawings, in which:

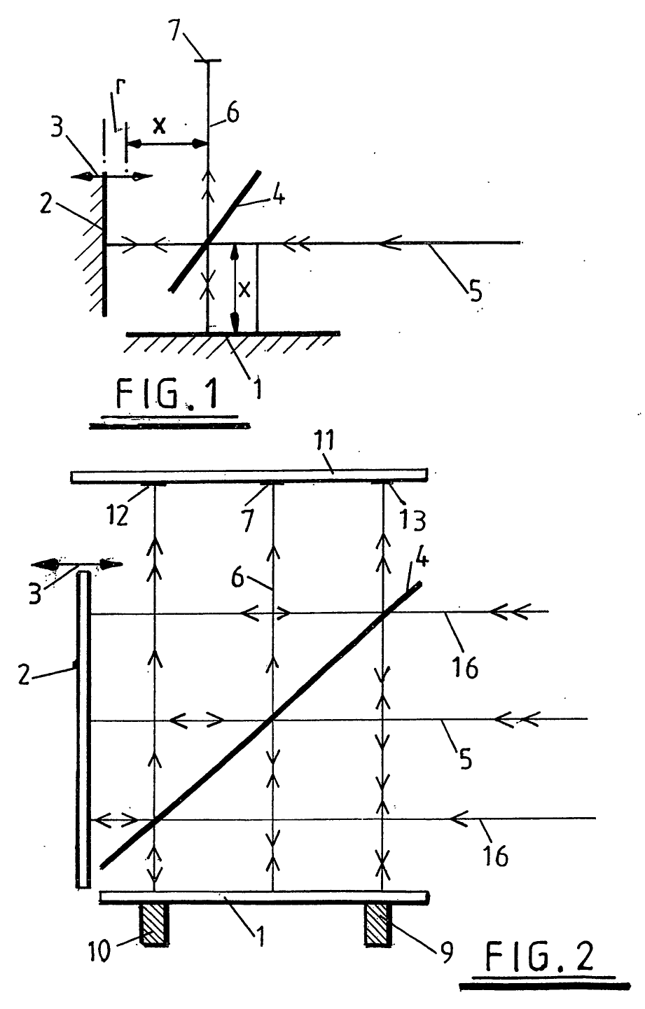

FIG. 1 is a schematic representation of a Michelson interferometer;

FIG. 2 illustrates the incorporation of additional optical sources and detectors which may be used in accordance with the present invention to initially align and maintain the alignment of mirror components of an interferometer such as that shown in FIG. 1;

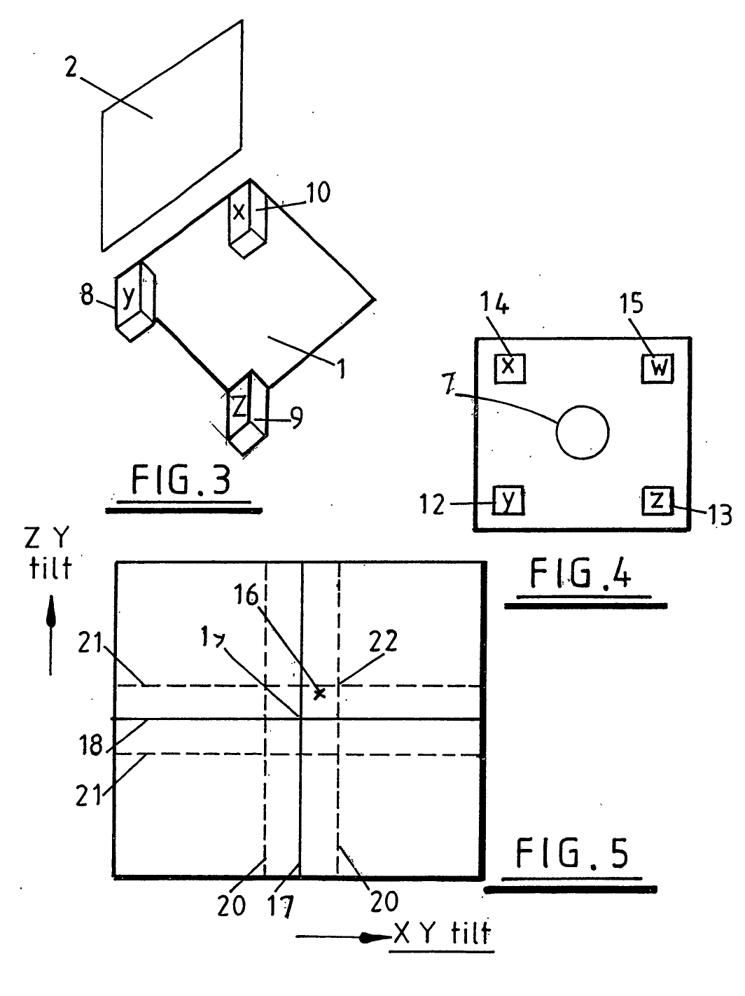

FIG. 3 is a view from below of the mirrors of FIG. 2 showing three actuators on which one of the mirrors is mounted;

FIG. 4 represents the disposition of four detectors relative to a plan view of one of the mirrors shown in FIGS. 1 and 2;

FIG. 5 shows lines schematically representing tilt angles for which different pairs of detectors indicate detector signals are in phase;

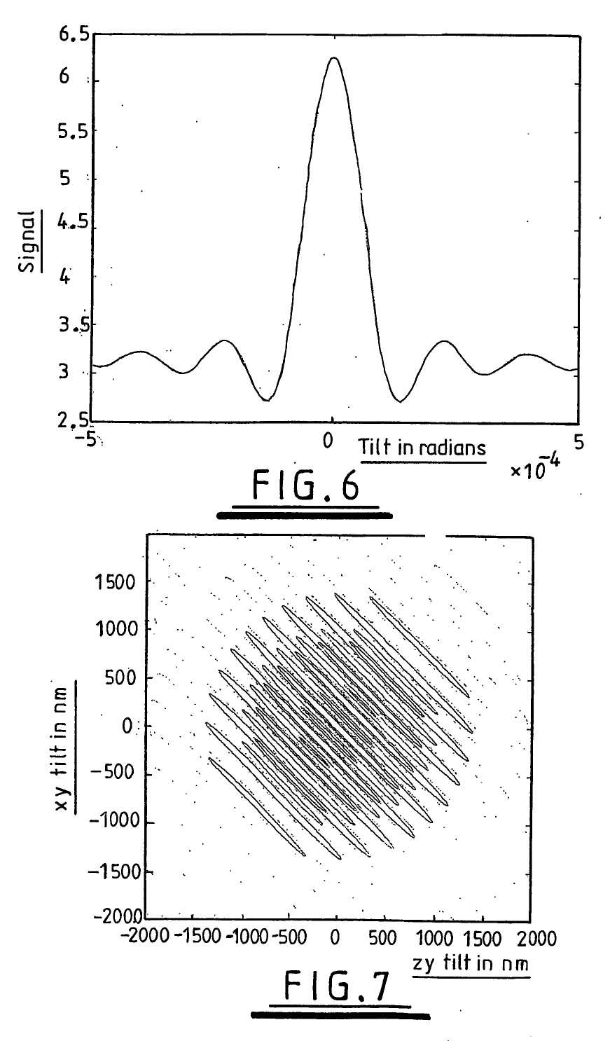

FIG. 6 represents attenuation gain with mirror tilt about one axis;

FIG. 7 represents the magnitude of the output of the one of the detectors for different tilts in two orthogonal directions;

FIG. 8 represents signals for all four detectors shown in FIG. 4 assuming tilting about two orthogonal axes and the maintenance of one actuator in a fixed position;

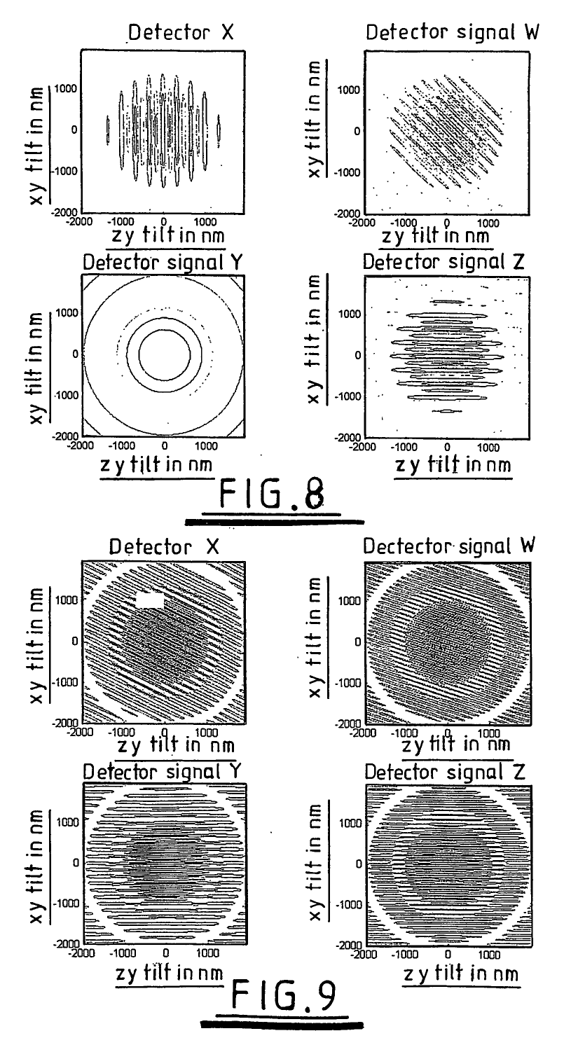

FIG. 9 represents the detector outputs shown in FIG. 8 subject to an added displacement of all of the three actuators shown in FIG. 3;

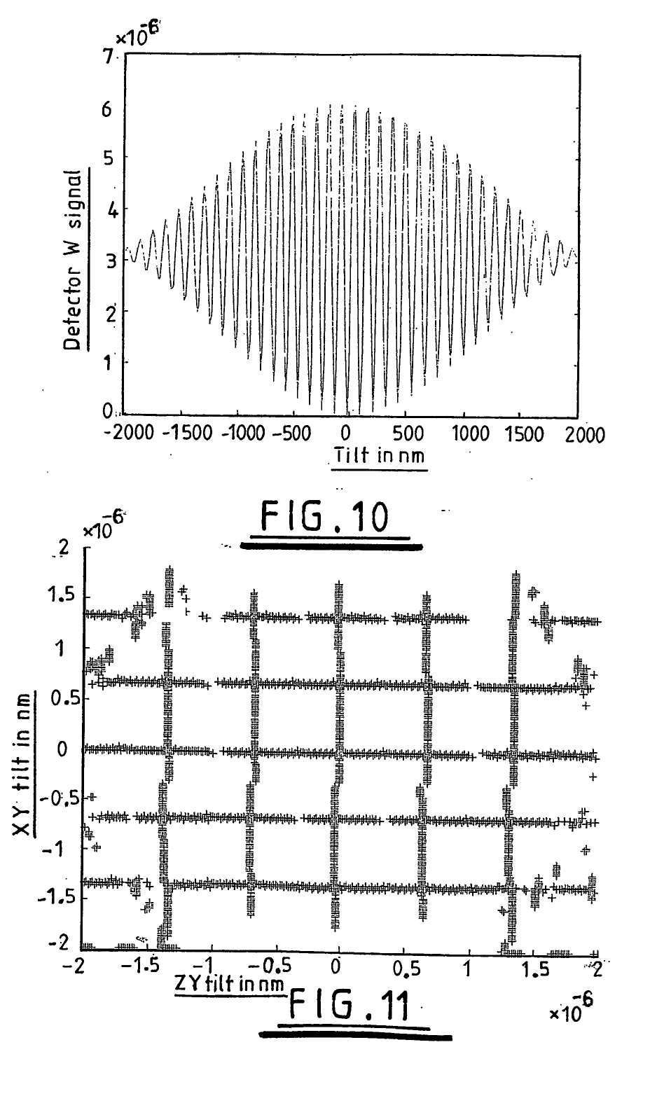

FIG. 10 shows a typical detector output signal corresponding to tilting the mirror about one of the orthogonal axes whilst maintaining the mirror fixed relative to the other orthogonal axis;

FIG. 11 represents the mirror positions at which the phase is constant as between the outputs of different pairs of detectors;

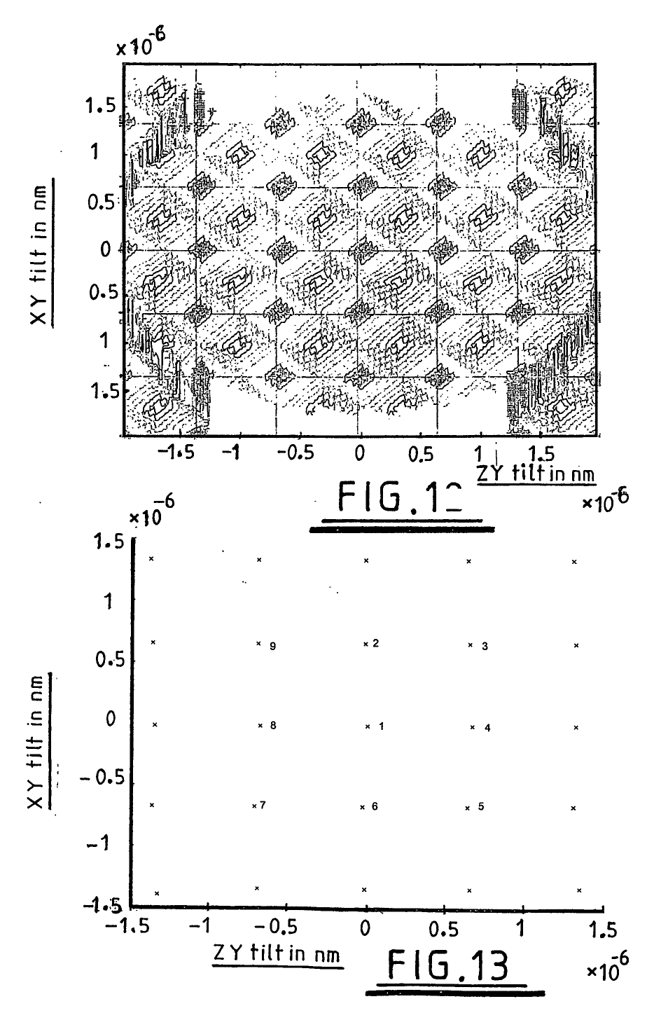

FIG. 12 represents the variation of the magnitude of phase differences between tilts in the two orthogonal directions;

FIG. 13 shows the position of points on the graph of FIG. 12 at which the phase difference is a minimum; and

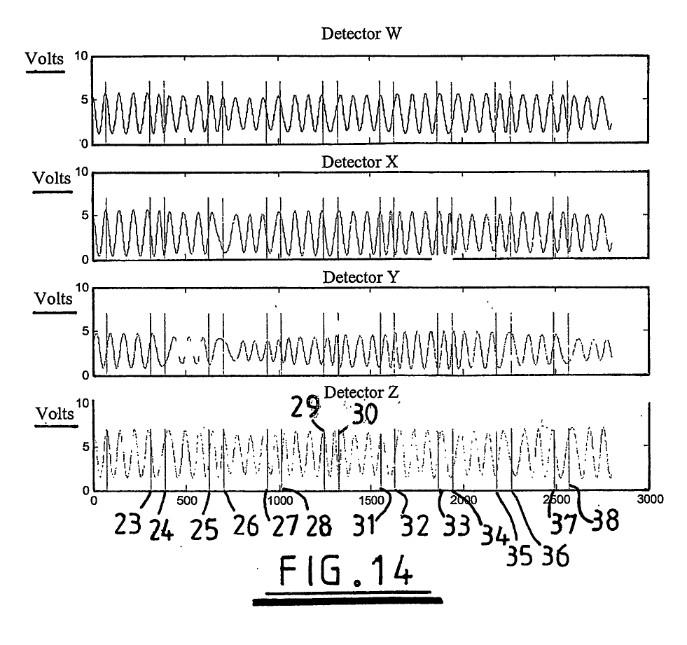

FIG. 14 represents the magnitude of the output signals from the four detectors of FIG. 4 for each of the nine labelled points of minimum phase difference shown in FIG. 13.

Referring to FIG. 1, the illustrated Michelson interferometer is one example of an optical instrument to which the present invention may be applied. The illustrated instrument comprises a first mirror 1 which is fixed in position and a second mirror 2 which is displaceable in the direction of the arrow 3. The mirrors 1 and 2 are planar and are held at right angles to one another. A beam splitter 4 is inserted between the mirrors in the path of an incoming light beam 5. The optical components are arranged so that the beam splitter 4 reflects approximately 50% of the incident beam towards the mirror 1 but passes approximately 50% to the mirror 2. The reflected beams of light from the mirrors pass through the beam splitter or are reflected by the beam splitter and are recombined into a single beam 6 which is directed towards a NIR (near infra red) analytical detector 7. Thus one beam component is deflected by the beam splitter, reflected again by the mirror 1, and then transmitted by the beam splitter. A second beam component is transmitted by the beam splitter, reflected by the mirror 2 and reflected again by the beam splitter. The paths of the two beam components directed from the beam splitter towards the detector 7 are collinear and coincident on the detector 7. The intensity sensed by the detector 7 depends upon the optical path difference between the paths travelled by the two beams. The optical path difference is varied by moving the mirror 2 relative to the beam splitter 4. This in turn varies the intensity of the light incident on the detector 7 in a way that makes it possible to derive the spectral structure of the incident light beam 5. This spectral structure can be used to determine characteristics of the light source and the material that the light has either passed through or been reflected from.

In the instrument illustrated in FIG. 1, the mirrors 1 and 2 are intended to be orthogonal, and the beam splitter 3 is arranged at an angle of 45° to each mirror. Other configurations are possible, and indeed it is often preferred to use beam splitters at near normal angles to incident beams in order to avoid polarisation effects. The configuration of FIG. 1 is however geometrically simply and has been selected for descriptive purposes only.

FIGS. 2, 3 and 4 illustrate an embodiment of the present invention which incorporates the essential components of a Michelson interferometer such as that shown in FIG. 1 but in addition incorporates components which enable the initial alignment of the mirrors 1 and 2 and the maintenance of appropriate alignment during use of the instrument. The mirror 1 is supported on three actuators 8, 9 and 10, the mirror 1 facing a support 11 for the analytical detector 7 and four further detectors 12, 13, 14 and 15. The actuator 8 is aligned with the detector 12, the actuator 9 is aligned with the detector 13, and the actuator 10 is aligned with the detector 14. The detector 15 is located at the fourth corner of the square support 11.

Each of the detectors 12 to 15 is positioned so as to be arranged to detect a respective one of four parallel alignment control beams 16 two of which are shown in FIG. 2. The alignment control beams 16 could be generated by separate monochromatic sources but generally will be generated by beam splitting a single beam delivered by a monochromatic source. Each of the beams 16 is directed through the instrument in exactly the same manner as the main beam 5 and therefore will be subject to beam splitting and recombination in exactly the same manner as the main beam 5. Thus displacement of the mirror 1 will affect all of the five beams passing through the instrument. When the mirrors 1 and 2 are perfectly aligned, the signals measured at the detectors 12, 13, 14 and 15 will be exactly in phase. If the actuators 8 and 10 are not moved but the actuator 9 is moved, the mirror 1 will tilt about a first axis extending parallel to the direction in which the actuators 8 and 10 are spaced apart. There will be no resultant change in the distance between the actuators 8 and 9 and the respective detectors 12 and 14. If in contrast the actuators 8 and 9 are not moved whereas the actuator 10 is moved, the mirror 1 will tilt about an axis parallel to the direction in which the actuators 8 and 9 are spaced apart and as a result the distance between the mirror supported by the actuator 10 and the aligned detector 14 will change whereas the distance between the portions of the mirror 1 adjacent the actuators 8 and 9 and the aligned detectors 12 and 13 will not change. Thus by appropriate control of the three actuators the mirror 1 can be tilted about two orthogonal axes so as to adjust the relative phase of components of the beams reaching each of the five detectors 7, 12, 13, 14 and 15. In embodiments of the invention there must always be the facility to tilt one of the components about two axes, and there must be at least three alignment beam and detectors arrangements to detect tilting about those axes. In the illustrated arrangement four alignment beam detector arrangements are provided but it will be appreciated that only three such arrangements are required.

Thus, in the described arrangement the actuators are arranged to define two orthogonal axes, and the detectors define two orthogonal axes. Furthermore, the actuators are aligned with respective detectors along the beam paths. This simplifies the analysis of alignment errors and correction for such errors, and the bulk of the following description relates to such a simple configuration. However, less simple configurations with non-orthogonal detectors and non-orthogonal actuators can be readily envisaged. Even in such more complex arrangements however the same principles can be applied, subject only to the use of relatively simple mathematical transformations to take account of the less simple geometry.

Referring again to FIGS. 2 to 4, it will be appreciated that the main beam 5 defines the optical axis of the instrument. The additional detectors and monochromatic alignment beams are disposed symmetrically around the main optical axis in alignment (after reflection in the beam splitter 4) with the corners of the mirror 1 and therefore also in alignment with the four detectors 12, 13, 14 and 15.

Although normally the symbols X, Y and Z are used to define a three-dimensional space with each of the symbols being applied to one of three mutually orthogonal axes, in this document those symbols will be used to represent extensions of the three actuators 8, 9 and 10. Thus extension of the actuator 8 results in a Y displacement, extension of the actuator 9 a Z displacement, and extension of the actuator 10 an X displacement. Such extensions result in tilting of the mirror 1. As described below, a ZY tilt will result if the Y actuator 8 is not moved whereas the Z actuator 9 is moved. Similarly, an XY tilt will result if the Y actuator is not moved whereas the X actuator 10 is moved. Tilting of the mirror 1 is described below in terms of XY and ZY tilt.

The detectors 12, 13, 14 and 15 are aligned respectively with the Y actuator 8, the Z actuator 9, the X actuator 10 and the corner of the mirror 1 diagonally opposite the Y actuator 8. These four detectors are therefore referred to below as the Y detector 12, the Z detector 13, the X detector 14, and the W detector 15, each of the detectors producing an output signal representative of displacement of the respective corner of the mirror 1. Given that in the simple illustrated instrument the actuators and detectors are aligned with each other and the axes are orthogonal, the movement of one pair of actuators will not affect the relative phase of the beams detected by the detector pairs associated with the other actuator pair. If the actuators and detectors were not aligned, moving one actuator pair would change the relative phase in both detector axes. Even in such a more complex geometrical arrangement however detected patterns could be converted, by use of an appropriate mathematical transformation of coordinates, into the patterns that would have been made had the actuator and detector sets been aligned. Similarly, a transformation could be used to convert patterns resulting from non-orthogonal axes to those that would have been obtained if the axes had been orthogonal. For the purposes of the present description however the relatively simple geometry represented in FIGS. 2 to 4 will be assumed.

Alignment is controlled in three distinct stages, that is a first stage which performs an approximate initial alignment based on monitoring the magnitude of the outputs of the detectors, a second stage which relies upon the relative phase of beams reaching the detectors to provide an estimate of improved accuracy, and a third stage which compares alternative estimates to ensure the accuracy of the second stage estimation.

In the first stage, the actuators are displaced in a predetermined pattern so as to obtain a plot of intensity information at each of the four detectors as the alignment is systematically scanned in two dimensions. These 2-D plots represent the intensity produced by the two interfering beams at the detectors The maximum magnitude points of each of the two dimensional intensity plots provides an estimate of a correct alignment position for the mirror for that detector. The four resultant estimates are then combined to produced an initial estimate of the correct alignment position. The objective is to align the centre of the interference pattern over the main detector 7 since this is the detector that is used to measure interferograms. The estimated alignment positions of the four detectors 12, 13, 14, 15 are used to produce a single estimate of the alignment position of the main detector 7. The relative position of each of the detectors (12, 13, 14, 15 in FIG. 4) with respect to the main detector 7 is known. Thus each of the estimates of the correct alignment position for the detectors 12, 13, 14, 15 can by simple geometry be used to obtain an estimate of the correct alignment position for the main detector 7. These four resulting estimates of the correct alignment position for the main detector are combined (by averaging for example) to obtain a single estimate of the alignment position for the main detector.

The detector signal may be noisy. Improved estimation of the correct alignment point is obtained in the second stage by using phase information from the two-dimensional images rather than the magnitude information as used in the first stage. This second stage relies upon the fact that the maximum magnitude in the detector signals should occur at a point when all four detector signals are in phase. Thus the two dimensional images are used to make a further plot of the lines at which the signals from the XY pair of detectors 12 and 14 and a ZY pair of detectors 12 and 13 are in phase.

Given that the XY detectors 12 and 14 are spaced apart in a direction perpendicular to the direction of separation of the YZ detectors 12 and 13, any ZY tilt will not alter the relative phases of the X and Y detectors 12 and 14. Therefore, there will be a number of XY tilt positions at which the outputs of the XY detectors 12 and 14 will be in phase regardless of the output of the Z detector 13 and equally there will be a number of values for ZY tilt at which the outputs of the Y and Z detectors 12 and 13 will be in phase regardless of the output of the X detector 14. Referring to FIG. 5, this schematically represents XY and ZY tilt of the mirror 1. The cross 16 represents tilt values corresponding to the initial alignment estimate produced by the first stage of the alignment process. The line 17 represents an XY tilt value for which the outputs of the Y and Z detectors 12 and 13 are in phase regardless of XY tilt and the line 18 represents a ZY tilt value for which the outputs of the X and Y detectors 12 and 14 are in phase regardless of XY tilt. The point of intersection 19 of lines 17 and 18 represents a second estimate of the true tilt position corresponding to alignment.

In practice, there will be a number of lines parallel to the line 17 each of which represents a possible aligned position and a number of lines parallel to the line 18 each of which corresponds to a possible aligned position. The point of intersection selected is that which is closest to the initial estimated alignment position represented by cross 16. Given that the sets of lines parallel to lines 17 and 18 are spaced at 2π intervals in the ZY and XY tilt directions it may be that the “correct” point of intersection is not that which is closest to the initial estimate 16 but rather is a point of intersection slightly further away from the initial estimate position represented by cross 16. The third stage of the alignment process ensures that the “correct” point of intersection is selected.

In the third stage, alternative alignment positions are investigated and further corrections made if necessary on the basis of that investigation. Having initially selected the point of intersection 19 closest to the initial point 16, the points of intersection for the two closest adjacent in-phase positions in both the XY and ZY tilt directions are identified. In FIG. 5, these positions are represented by the additional lines 20 parallel to line 17 and the additional lines 21 parallel to line 18. The lines 17, 18, 20 and 21 intersect at nine points, that is the intersection point 19 and the eight intersection points spaced around point 19. The mirror 1 is scanned backward and forward in the same procedure as is used when collecting data for the two-dimensional images relied upon in the first stage. The detector signals which result will be a set of sinusoidal signals which are maintained in phase during the scan to maintain the initial alignment of the mirrors. This process of dynamic control is known and has been discussed in for example U.S. Pat. No. 4,413,908. In addition to this known dynamic control however in the third stage of the alignment process the eight points around the intersection point 19 are systematically probed. Thus during a single scan, the dynamic control system moves the mirror in turn to each of the eight positions represented by the intersection point surrounding point 19. The magnitudes delivered by the four detector signals are measured at each of these eight points and compared with the magnitude at the mirror position corresponding to the intersection point 19. These monitored magnitudes are equivalent to measurements of the magnitude signals during the first stage of the process. By comparing the measured magnitudes, a further estimate of the accuracy of mirror alignment is derived. For example, if this investigation indicated that the magnitude at the point corresponding to intersection point 22 in FIG. 15 was greater than at intersection point 19′, the system would automatically move the mirror on the basis that the “correct” aligned position is the XY and ZY tilt corresponding to the intersection point 22.

The alignment process described in general terms above will now be described in greater detail with reference to FIGS. 6 to 14.

When the mirrors in a Michelson interferometer are tilted and the light source is a monochromatic source (usually a laser) interference patterns are generated which are scanned across the detector. The signals measured at the detector depend on the optical path difference for the light from the two mirrors (mirrors 1 and 2 in FIG. 1) and also on any misalignment between the mirrors. The interference pattern at each of the four detectors 12 to 15 represented in FIG. 4 is determined by the optical path difference, and the signal at each end of the interferogram is attenuated depending on the amount of the misalignment. (The attenuation also depends on the diameter of the detectors, with larger detectors being more sensitive to misalignments). The detector signal D can be calculated by integrating the square of the intensity over the area of the detector:

$$D = {\int }_{- r}^{r} 2 {sin}^{2} ( \frac{2 π α x}{λ} + β ) \sqrt{{r}^{2} - {x}^{2}} ⅆ x$$

Where α is the tilt angle, λ is the source wavelength, r is the detector radius, β is a phase term given below.
β=2π(opd)/λ
And opd is the optical path difference at the centre of the detector.
FIG. 6 shows the theoretical attenuation for a laser source of wavelength of 670 nm, a detector of radius of 2 mm and the mirror tilt varying from −0.0005 radians to 0.0005 radians. This tilt is obtained with actuators 2 cm apart and one of which moves 20 microns.

Thus, if the Y piezoelectric actuator 12 is maintained stationary, FIG. 7 shows the expected magnitude variations in the detected W signal, where the optical path difference is the sum of the two movements of the X and Z actuators 13 and 15 relative to the Y actuator 12. The ZY tilt changes the difference between the optical path difference at the Z detector and that at the Y detector 12.

The two-dimensional plot of FIG. 7 shows constant magnitude contour lines for the detector signal for the various tilts, each contour line showing a respective magnitude. It will be appreciated that FIG. 6 represents the variation of magnitude along the line drawn across the detector signal contours of FIG. 7. The maximum detector signal is at the centre (corresponding to zero tilt in this idealised diagram). Given the two-dimensional plot of FIG. 7, it is possible to identify the correct alignment position by finding the point at which the detector signal is a maximum.

Greater accuracy can be achieved by monitoring the magnitude at all four detectors. FIG. 8 shows plots for all four detectors, assuming no movement of Y actuator 12.

The signals for detectors X, W and Z shown in FIG. 8 can be used to determine the mirror tilt position giving a maximum magnitude signal, but the signal for Y is not useful because the Y actuator 12 is not moving. To get a useful signal from all four detectors, a ramp change is added to the all the actuators at the same time as changing the XY and ZY tilts. FIG. 9 show the result with an extra 20 micron movement in the optical path difference obtained by adding such a ramp. The orientation of the contours can be changed if desired by adding the ramp in different ways.

The two-dimensional plots shown in FIG. 9 can be used to obtain an estimate of the correct alignment point for each detector using a method that finds the maximum point in the envelope of the two-dimensional surfaces. These estimates, together with the geometry of the detectors and the main (analytical) NIR detector 7, can be used to obtain four estimates of the correct alignment point for the main NIR detector.

A number of methods can be used to find the maximum points from the four detector signals. In one method, the tilts for minimum attenuation can be found by fitting a quadratic surface to the peaks of the detector signals, in the individual scans. FIG. 10 shows a typical expected detector signal for a scan in the XY tilt direction keeping the ZY tilt constant. At the peaks on this curve the cosine term in the detector output will be unity. Therefore a surface fitted to the peaks will approximate kA(θ), where k is a constant depending on the detector gain and A(θ) is the attenuation due to tilt angle θ. So the peaks give points on the attenuation surface which is approximately a two dimensional quadratic. Least squares fitting can be used to fit a quadratic to all the peaks, which are sufficiently large. For example, all the peaks where the gain A is at least 0.7 may be used. This then gives the points of minimum attenuation for each detector which indicate the tilts required to align the mirrors at the detectors. Any individual detector could be used, but a better estimate is obtained by using all four detectors.

It is possible to find the overall optimum by successive searches along orthogonal directions. For example first scan through a set of XY tilts while keeping the ZY tilt constant at ZY₀. This gives a “cut” through the surface as in FIG. 10. One-dimensional quadratics can be fitted to the larger peaks in order to find the peak of the envelope containing the signal. This gives a best XY tilt XY₁ for the ZY tilt ZY₀. Next scan through a set of ZY tilts while keeping the XY tilt constant at XY₁. This gives another “cut” through the surface as in FIG. 10. One-dimensional quadratics can be fitted to the larger peaks in order to find the peak of the envelope containing the signal. This gives a best ZY tilt ZY₁ for the original XY tilt XY₁. The process is then repeated with the ZY tilt ZY₁. This iteration converges fairly rapidly due to the overall surfaces in FIG. 9 having symmetry. A separate search has to be made for each detector.

The above procedure is used to obtain the estimates of the correct alignment angle for each detector—and these in turn give four estimates of the correct alignment position for the main detector 7 (FIG. 4). These four estimates may be combined to produce an initial estimate of the “correct” alignment position.

In the second stage of the process, the relative phases of the detector signals are used to improve the estimate of the true detector magnitude maximum. When the mirrors are exactly aligned, the optical path differences for the four detectors will be equal, and the detector signals will be in phase. Therefore the correct alignment point of the mirrors occurs at a pair of XY and ZY tilts which give the same phases for each of the detectors 12 to 15. FIG. 5 shows lines for which the X and Y detectors are in phase and the Z and Y detectors are in phase for the maximum detector magnitude. However the phase is periodic and so these lines repeat at tilt intervals of a wavelength, so that the true maximum in the detector magnitude maybe at any of the intersections of the zero relative phase lines. The tilt angles corresponding to these lines of zero relative phase are calculated and then used to improve the estimates of the detector alignment points obtained from the first stage.

At each of the peaks of the detector signals found in the first stage, the phase difference will be zero or 2πn, where n is an integer. Hence by linear interpolation between the peaks we can find the phase of the signal at the particular detector. This can be done for each point on the XY, ZY tilt planes shown in FIG. 9. The X and Y detectors will have equal phase along a set of zero relative phase lines one wavelength apart in tilt actuator positions, with constant XY tilt. The Z and Y detectors will have equal phase along lines with constant ZY tilt. There should be a grid of points where these lines intersect, which are a wavelength apart in tilt angle in each direction, and where the phases of all four detector signals are equal. The lines of equal phase can be calculated from the magnitude plots (FIG. 9) using linear interpolation. FIG. 11 shows the results of calculating the lines of equal phase from the plots shown in FIG. 9.

The intersection points of the lines in FIG. 11 correspond to points at which all detectors have the same phase. The plot of FIG. 11 was obtained by a computer simulation of an actual embodiment. The lines which in theory should be straight are in fact not so. Nevertheless, these lines accurately represent what can be expected in an actual embodiment given inevitable measurement errors. One of these intersection points should correspond to the zero phase point at which the magnitude is a maximum. In practice however this will not generally be the case due to inaccuracy in the estimation of the position of maximum magnitude. In addition, the lines in FIG. 11 should be straight, but the calculation method used is necessarily approximate. Therefore the accuracy of the second stage process is increased by finding the grid of points where the estimated phases of the detectors are closest. One of the ways of finding these points of ‘closest phase’ is to find the sum of the magnitudes of the phase differences between the detectors. FIG. 12 shows the contours of the surface representing the sum of the magnitudes (again this picture is approximate due to the calculation method). Points at which the sum of the magnitudes are local maxima (minimum phase difference) are shown by crosses. These crosses correspond to estimates of the tilt positions at which the lines of equal detector phases cross, and all the detector phases are equal. The area is then divided into squares, and the point of ‘closest phase’ in each square is plotted to form the grid pattern of FIG. 13. Each of the crosses in FIG. 13 labelled 1 to 9 is a candidate maximum point.

One of these grid points in FIG. 13 corresponds to the mirrors being aligned with all four optical path differences being equal. The grid point nearest to the estimate obtained in the first stage is then selected as the best estimate of the true alignment point. Note however that this point (labelled 1 in FIG. 13) is an estimate, and the points around it (labelled 2 to 9 in FIG. 13) could also be accepted as reasonable estimates of the true alignment position. These points are tested in the third stage of the alignment algorithm to check the accuracy of the alignment and test for a better alignment point during the operation of the interferometer.

During normal operation, the mirrors 1, 2 are moved with respect to each other by either applying the same displacement to all piezo-actuators attached to mirror 1 or by having a separate device to move the other mirror 2. The normal sequence of operation will be that the mirrors will be initially aligned using the methods described in the first and second stages. This gives the set of tilts that are required to place the interferometer mirrors in alignment. A separate dynamic control scheme is then used during the collection of interferograms. The function of the dynamic control system it to keep the mirrors in alignment during the displacement of the moving mirror. This is done by measuring the laser detector signals X, Y, Z, during the moving mirror scan.

The laser source is monochromatic, and therefore the detector signals during the scan are a set of sine waves. The dynamic control scheme measures the relative phases of the detector signal sine waves and adjusts the actuator tilts to maintain the relative phases at zero. If the initial alignment algorithm worked correctly, then the zero phase point corresponds to the zero relative phase point marked as 1 in FIG. 13, and hence the zero phase point which gives the maximum magnitude signal at the detector 7. However, the point 1 in FIG. 13 is in fact an estimate of the correct alignment position, and the surrounding points (labelled 2 to 9) are also possible points for the correct alignment position. If the first and second stages of the initial alignment were grossly in error then the correct alignment point might be at some other zero phase point in the grid on FIG. 13.

The third stage of the alignment process is performed during scanning of the mirror. The validity of the selected grid point (point 1) is checked within the dynamic control process by performing a test scan during which the tilts are periodically changed to align the mirrors at grid points 2 to 9 (in FIG. 13) in turn. The detector signal magnitudes at each of the grid points are then measured. The magnitudes measured at these grid points are in fact points on the two-dimensional magnitude plots for each of the detectors. Thus a further curve fitting can be used to determine an estimate of the position of maximum detector signal for each detector. This can be done while scanning the optical path difference through thirty wavelengths and so can be done in a single scan of the instrument.

FIG. 14 shows the detector signal for a pattern of tilts going round the points number 1 to 9 on FIG. 13. Between the lines 23 and 24 the tilt position is changing from point number 1 to point number 2. The tilt positions for the control process are then kept constant until the next line 25 is reached, and the detector signal is measured as the mirror is scanned between the positions as indicated by lines 24 and 25. This process is repeated for each of points 3 to 9, such that mirror tilting occurs between lines 25 and 26, 27 and 28, 29 and 30, 31 and 32, 33 and 34, 35 and 37 and 38, whereas the detector signal is measured between lines 26 and 27, 28 and 29, 30 and 31, 32 and 33, 34 and 35 and 36 and 37. The peaks of the quadratic fits to this data are used to either confirm that the current grid point 1 is the correct alignment point, or to pick another grid point as a better estimate of the correct alignment point, or to initiate a re-alignment from stage 1. In the case illustrated in FIG. 14, grid point 6 (between lines 32 and 33) would be selected as the point providing the greatest magnitudes.

Thus, the invention provides a method of initially aligning the mirrors in a two-beam interferometer and subsequently refining and checking the alignment during normal operation of the interferometer. In summary, the process relies upon three stages. In the first stage, a set of three piezo actuators is scanned through a pattern which produces two-dimensional images of detector signal magnitude for each of four detectors. The point at which the envelope of these two-dimensional plots reaches a maximum gives an estimate of the correct alignment position for each detector. Using the known geometry of the instrument these each form a separate estimate of the location of the correct alignment position (as defined by a set of tilts of one of the mirrors) for the analytical detector.

The second stage uses the fact that when the mirrors are aligned the relative phases of the detectors are zero, and that when the mirror is tilted in one axis the relative phases in the other axis are not altered. This is used to form a grid of zero relative phase points—one of which must be the point at which the mirrors are aligned. The best of these candidate alignment points is selected as the one nearest to the correct alignment estimated in the first stage.

The third stage of the alignment algorithm takes place during the scanning of the mirror under dynamic control. A set of alternative zero relative phase points that are around the selected point are visited and the magnitudes of the detector signals at these points is used to provide a further estimate of the correct alignment point. If this is the same as the current alignment point then no action is taken, if it is different then the instrument either moves to that point or initiates a full re-initialisation of the interferometer.

The invention provides several benefits. Firstly, initial alignment may be automatically implemented, thereby removing the necessity for this task to be carried out by a skilled operator. Secondly, alignment may be continuously or frequently checked and maintained. This increases confidence in the integrity of the measurement and offers the possibility of an automatic warning if for any reason the alignment fails and cannot be automatically restored. This has obvious benefits in any situation where the instrument is used in an application where there are regulatory, safety or other implications in the event of a loss of measurement accuracy. Thirdly, it prevents a progressive deterioration in performance after initial alignment, and so has implications for reducing the amount of routine service that may be required. Related to this is the possibility that the instrument can be designed and engineered to lower tolerances, especially with regard to mechanical stability, thereby reducing costs. The ability of the instrument to maintain alignment during operation offers the potential for using the instrument in adverse conditions in which prior art instruments would not be capable of reliable operation for extended periods of time. This is especially important when it is desired to extend the use of a measurement currently effected as a laboratory check onto a production line for example. The economic benefits of making a measurement continuously on a production line are frequently much greater than making the same measurement intermittently on samples taken from that line. Benefits typically include the saving of energy, the maintenance of high product quality and the reduction of the quantity of waste or defective product.

Although the invention has been exemplified with reference to a Michelson interferometer with orthogonal mirrors and with tilt axes that are mutually orthogonal, it will be appreciated that the invention may be applied more broadly. For example, the invention could be applied to an interferometer or other optical instrument with non-orthogonal mirrors, and three tilt inducing actuators could be arranged at the corners of an equilateral triangle rather than at the corners of a right-angle triangle as in the described apparatus. The actuators could be arranged in any configuration capable of inducing tilt about two different axes. Actuators and detectors need not be aligned with the beam path. More than three detectors and actuators may be provided, and the number of detectors and actuators need not be the same. The use of a greater number of detectors and actuators would enable self-checking using different sets of actuators/detectors, referring detectors to each other to reduce noise, and built-in redundancy to enable the system to operate even after failure of one detector/actuator.

As described above, the detectors and actuators need not be aligned with each other, although this is the most convenient configuration. When the detectors are not aligned with the actuators, then two of three actuators must be moved at once if a constant phase relationship is to be maintained between the detectors of one pair. (The same constant phase relationship is maintained by moving only one actuator at a time in the co-aligned case). Specifically, in order to ensure that the mirror tilts about a line joining two detectors (and thereby retain the constant phase relationship about this line) the movement of the actuators must be related in a way that depends upon the geometry of the actuators and detectors.

As a concrete example, consider the case where one detector is not aligned with an actuator position, and where the actuator pairs are orthogonal. Let the actuators be positioned at (x₀, y₀), (x₁, y₀) and (x₀, y₁), and the actuator (x₀, y₀) not move. Consider two detectors, one aligned with the stationary actuator at (x₀, y₀) and the second at a position (x′, y′). Let the line joining the two actuators at (x₀, y₁) and (x₁, y₀) be L, and let this line cross the line joining the fixed actuator at (x₀, y₀) and the detector at (x′, y′) at point M such that it cuts the line L into two parts, a and b, where the distance from (x₀, y₁) to M is a and the distance from (x₁, y₀) to M is b. To ensure that the mirror tilts about the line joining (x₀, y₀) and (x′, y′) the actuators should be moved so as to keep the point M stationary. Thus if actuator (x₀, y₁) is moved a distance zₐ, then actuator (x₁, y₀) should be moved a distance z_{b}, where

$${z}_{a} = - {z}_{b} \{ \frac{a}{b} \}$$

a and b are known from the geometry of the actuator and detector positions.

It will also be appreciated that the above transformation method can be extended to the case where no detector is aligned with an actuator. It will also be appreciated that the method can be used to calculate movements of two actuators so as to tilt the mirror about any axis which passes through the mirror.

It will also be appreciated that the invention could be described in any coordinate system which describes the location of a point within a space. Thus although the exemplary embodiment of the invention is described in terms of Cartesian coordinates, other coordinate systems, e.g. polar coordinates may be used.

1. (canceled)

2. A method according to claim 25, wherein the first axis and second axis are orthogonal.

3. A method according to claim 25, wherein the at least three alignment beams of monochromatic light are parallel.

4. A method according to claim 25, wherein the detectors are arranged such that tilting the optical element about the first axis does not affect the relative phase of components of each of the beams directed towards a first pair of the detectors and tilting the optical element about the second axis does not affect the relative phase of components of each of the beams directed towards the second pair of detectors, the second estimates of aligned element positions being derived by determining second element positions at which the phase differences between beams instant on each of the pairs of detectors are a minimum.

5. A method according to claim 25, wherein deriving the first element position includes calculating element positions from outputs of each of the detectors such that each said calculated element position corresponds to the position at which the magnitude of the beam incident on the respective detector is a maximum, and combining the calculated element positions to determine the first element position.

6. A method according to claim 25, comprising three detectors, one detector being included in each of the first and second pairs of detectors.

7. A method according to claim 6, wherein four detectors are provided.

8. A method according to claim 25, wherein after a set of second element positions is determined, and the element is aligned by moving it to the second position which is closest to the first element position.

9. A method according to claim 25, wherein after a set of second element positions is determined, and the optical element is moved to each of the set of second element positions in turn, the magnitude of an output of at least one of the detectors is monitored at each position, and the optical element is moved to the second element position at which the monitored magnitude is a maximum.

10. A method according to claim 25, wherein the optical element is a mirror.

11. A method according to claim 25, wherein the optical element is tilted by a plurality of actuators each of which is aligned with one of said respective detectors.

12. An apparatus for aligning an optical element of an optical interferometer, comprising
means for directing at least three alignment beams of monochromatic light through the optical interferometer towards respective detectors, the detectors being arranged in pairs where tilting the optical element about a first axis affects a relative phase of components of each of the alignment beams directed towards a first pair of detectors in a predetermined manner, and tilting the optical element about a second axis affects a relative phase of components of each of the alignment beams directed towards a second pair of detectors in a predetermined manner;
means for deriving a first estimate of an aligned optical element position by determining from an output of at least one detector a first element position at which a magnitude of the beam incident on the at least one detector is a maximum;
means for deriving second estimates of aligned element positions by determining second element positions at which predetermined phase differences between the at least three alignment beams incident on each of the pairs of detectors are established; and
means for aligning the optical element by moving it to a final position which is one of the second positions which is at or adjacent the first position.

13. An apparatus according to claim 12, wherein the first axis and second axis are orthogonal.

14. An apparatus according to claim 12, wherein the at least three alignment beams are parallel.

15. An apparatus according to claim 12, wherein the detectors are arranged such that tilting the optical element about the first axis does not affect the relative phase of components of each of the beams directed towards a first pair of the detectors and tilting the optical element about the second axis does not affect the relative phase of components of each of the beams directed towards the second pair of detectors, means being provided to derive the second estimates of aligned element positions by determining second element positions at which the phase differences between beams incident on each of the pairs of detectors are a minimum.

16. An apparatus according to claim 12, wherein the optical element is a tiltable mirror.

17. An apparatus according to claim 16, wherein a an additional mirror is positioned adjacent to and at an angle to the tiltable mirror and a beam splitter is positioned between the additional mirror and the tiltable mirror so components of the at least three alignment beams are transmitted through the beam splitter, reflected by one of the additional mirror and the tiltable mirror, and reflected again by the beam splitter to the detectors, and components of the at least three alignment beams are reflected by the beam splitter, reflected by the other mirror of the additional mirror and the tiltable mirror, and transmitted through the beam splitter to the detector.

18. An apparatus according to claim 17, wherein the additional mirror and the tiltable mirror are orthogonal.

19. An apparatus according to claim 12, wherein the optical element is mounted on actuators, each of which is aligned with a respective detector.

20. An apparatus according to claim 12, further including means for calculating element positions from the outputs of each of the detectors such that each said calculated element position corresponds to the position at which the magnitude of a beam incident on the respective detector is a maximum, and
means for determining the first element position by combining the calculated element positions.

21. An apparatus according to claim 12, comprising three detectors are provided, one detector being included in each of the first and second pairs of detectors.

22. An apparatus according to claim 21, wherein four detectors are provided.

23. An apparatus according to claim 12, further including means for determining a set of second element positions, and
means for moving the optical element to the second position which is closest to the first element position.

24. An apparatus according to claim 12, further including means for determining a set of second element positions,
means for moving the optical element to each of the set of second element positions in turn,
means for monitoring the magnitude of an output of at least one of the detectors at each of the set of second element positions, and
means for moving the optical element to the second element position at which the monitored magnitude is a maximum.

25. A method for aligning an optical element of an optical interferometer, comprising:
directing at least three alignment beams of monochromatic light through respective detectors, the detectors being arranged in pairs such that tilting the optical element about a first axis affects a relative phase of components of each of the beams directed toward a first pair of detectors in a predetermined manner and tilting the optical element about the second axis affects the relative phase of components of each of the beams directed towards the second pair of detectors in a predetermined manner;
deriving a first estimate of an aligned optical element position by determining from an output of at least one detector a first element position at which a magnitude of the beam incident on that detector is a maximum;
deriving second estimates of aligned element positions by determining second element positions at which predetermined phase differences between beams incident on each of the pairs of detectors are established; and
aligning the optical element by moving the optical element to a final position which is one of the second positions that is at or adjacent the first position
